(19) United States
(12) Patent Application Publication
(10) Pub. No.: US 2005/0092443 A1
(43) Pub. Date: May 5, 2005

(54) Device for mounting a tyre on a vehicle rim

(76) Inventor: Willy Ghyselinck, Zedelgem (BE)

Correspondence Address: Dykema Gossett, Suite 300 West, 1300 I Street NW, Washington, DC, 20005-3306, US

(21) Appl. No.: 10/500,338

(22) PCT Filed: Jan. 2, 2003
(86) PCT No.: PCT/BE03/00001

(30) Foreign Application Priority Data
Dec. 27, 2001 (EP) 01000795.3

(51) Int. Cl. B60C 25/128

(52) U.S. Cl. 157/1.28

(57) ABSTRACT

The invention concerns a device for mounting a tyre on a vehicle rim, said device comprising first means (1) designed to receive the rim and place it in position for mounting the tyre, an arm (2) whereof the first end is provided with a head for mounting (4) the tyre on the rim, said head (4) being arranged rotatable about is axis of symmetry, second means (3a, 3b, 3c, 3d) connected to the second end of the arm (2) and designed to impart to said arm (2) a rotational movement about the axis of symmetry of the rim in position for mounting the tyre. The arm (2) is inclined on the axis of symmetry of the rim in the position for mounting the tyre at an acute angle, the first end of said arm (2) being thus furthest from the axis of symmetry of the rim in the position for mounting the tyre. Thus, the movement of the arm (2) will not be obstructed by the skew position of the tyre on the rim when it reaches the device.

The present invention relates to a device for mounting a tire on a vehicle rim. Such a device comprises a first means designed to receive the rim and place it in the tire mounting position, an arm, a first end of which is equipped with a head for mounting the tire on the rim, said head being arranged so as to rotate on said arm, and a second means connected to the second end of the arm and designed to transmit to said arm a movement of revolution about the axis of symmetry of the rim in the tire mounting position.

Each sidewall of a tire comprises, on its edge inside said tire, a generally circular bead, comprising a cable that is often made of metal and is designed to be mounted on a corresponding flange or seat present on the inner periphery of each flank of a rim. The diameter of the bead in question is usually slightly smaller than that of the rim so that the bead has to be forced onto the corresponding flange of the rim, so as to ensure that the tire is held in place as the wheel comprising said tire mounted on its rim travels along a road. The mounting head of a device for mounting a tire on its rim carries out this function of forcing the bead of each sidewall of the tire onto the flange of the corresponding rim. This head may consist of a fixed or mobile element, usually arranged at one end of a mounting arm of a device for mounting a tire on a vehicle rim and having a shape suitable for the forcing in question.

A device for mounting a tire on its rim according to the prior art is known from EP482701. Said document describes a device intended in particular for mounting a tire on a vehicle rim and for dismounting this tire from its rim, in which the arm bearing the mounting head is fixed and the means designed to receive the rim and place it in the mounting position can rotate. According to said document, the arm bearing the mounting head is arranged vertically, its axis being parallel to that of the rim in the tire mounting position.

Within the context of an industrial line for first mounting tires on their rims, the latter are brought to the mounting device by a transport means, for example a conveyor. During this transport, the tire corresponding to each rim is placed at an angle on the latter, so that its sidewalls are oblique with respect to the conveying plane of the rim and so that a portion of the tire is closest to the conveyor whereas the diametrically opposite portion is furthest away from it. A tire arriving in this position at the mounting device may disrupt the rotational movement of a vertical arm provided with the mounting head about the axis of symmetry of the rim, thus disrupting mounting of this tire on said rim.

The invention solves this problem by proposing a device for mounting a tire on a vehicle rim, in which said arm is inclined at an acute angle with respect to the axis of symmetry of the rim in the tire mounting position, the first end of the arm thus being furthest away from the axis of symmetry of the rim in the tire mounting position.

By virtue of this particular configuration of the arm of the device according to the invention, the latter describes a frustoconical revolution surface during its movement for mounting the tire on its rim, the base of this surface being formed by the curve described by the mounting head during this movement. By contrast, the vertical arm of a device according to the prior art describes a cylindrical revolution surface of the same base. Consequently, the movement of the arm of the device according to the invention will not be obstructed by the angled position of the tire on the rim when it arrives at said device under circumstances where it would be obstructed with a vertical arm according to the prior art. Moreover; the inclined position of the arm makes it possible to position the bead of the sidewall of the tire that is closest to the conveyor on the corresponding flange or seat of the rim without the bead of the sidewall of the tire that is furthest away from the conveyor disrupting this positioning and while preventing this latter bead from being itself positioned on the corresponding flange or seat of the rim at an inopportune moment, during positioning of the bead that is closest to the conveyor.

Preferred embodiments of the invention are described in the dependent claims.

The invention will now be described in more detail and by way of example, without limiting the scope thereof and with reference to the appended figures, in which:

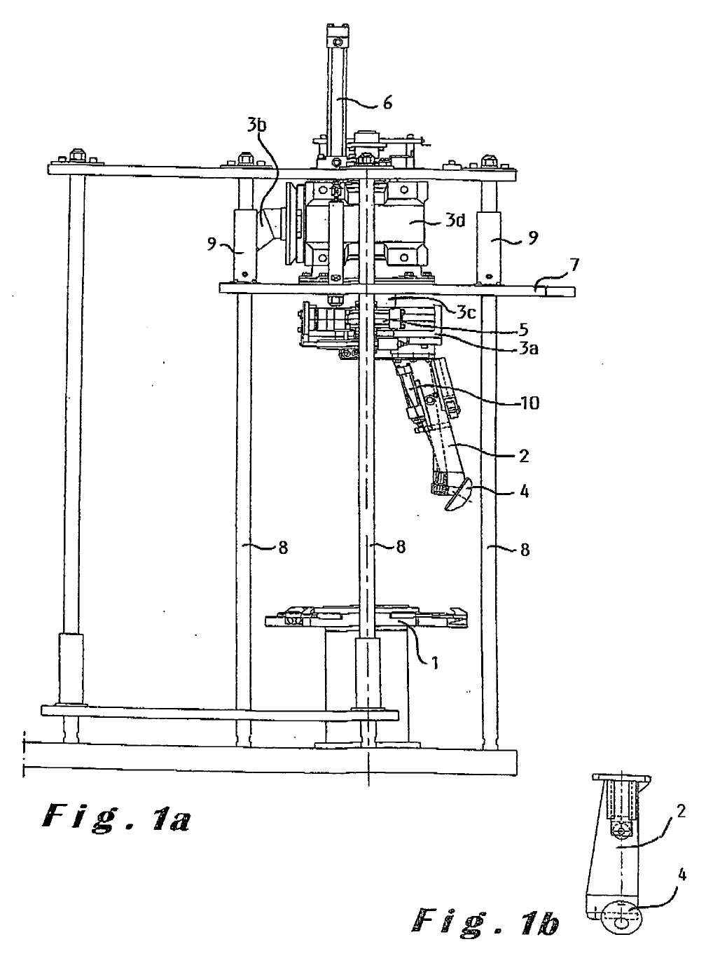

FIG. 1a shows a side view of a device according to the invention;

FIG. 1b shows a front view of the arm of the device shown in FIG. 1a, equipped with its head for mounting the tire;

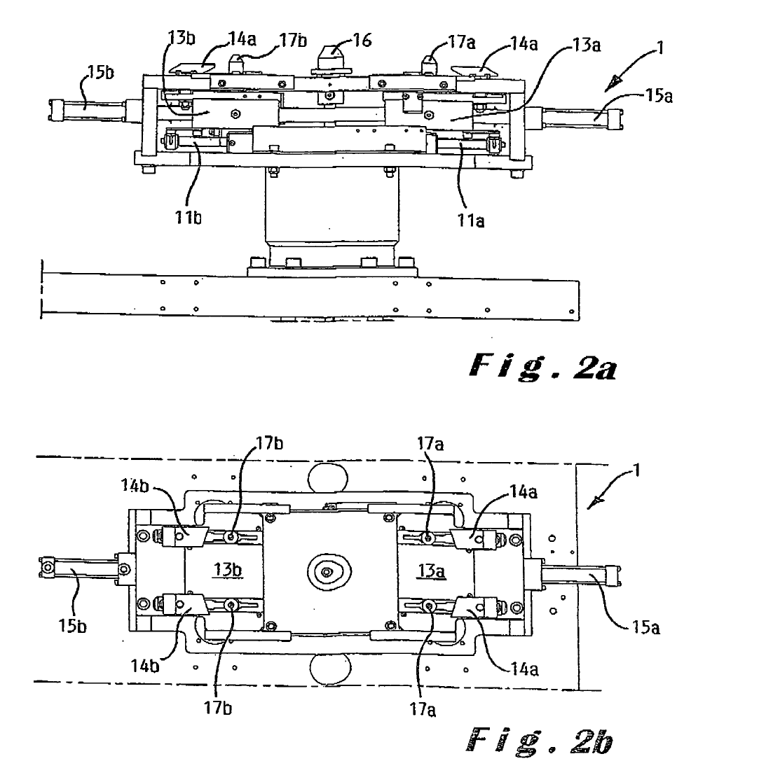

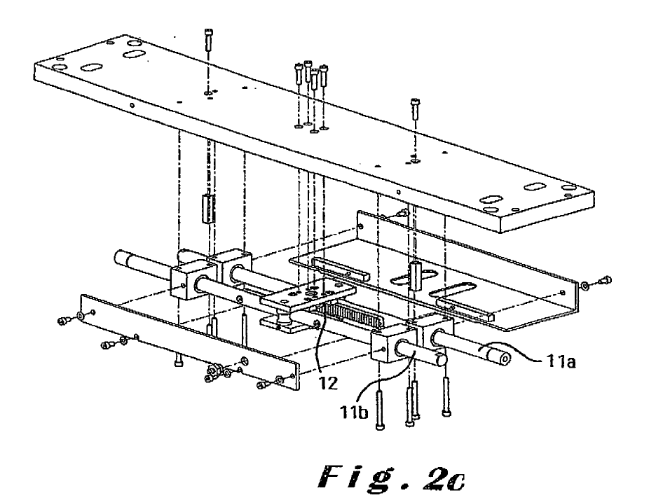

FIG. 2a shows a side view of a first means designed to receive a rim and to place it in the tire mounting position in a device according to the invention;

FIG. 2b shows a plan view of the first means shown in FIG. 2a;

FIG. 2c shows an exploded perspective view of a portion of the first means shown in FIGS. 2a and 2b.

FIG. 1a shows a device for mounting a tire on a vehicle rim according to the invention, this device comprising a first means 1 designed to receive the rim brought to the device by a conveyor (not shown) and place it in the tire mounting position. This first means is illustrated in more detail in FIGS. 2a to 2c. The device moreover comprises an arm 2, a first end of which is equipped with a head 4 for mounting the tire. The second end of the arm 2 is connected to a second means 3a, 3b, 3c, 3d designed to transmit to the arm 2 a movement of revolution about the axis of symmetry of the rim when it is in the tire mounting position on the first means 1. The second means 3a, 3b, 3c, 3d comprises a platform 3a to which the second end of the arm 2 is connected, a motor 3b designed to drive the arm 2 in said movement of revolution, this driving being carried out via a rotation spindle 3c that connects the motor 3b to the platform 3a via an element 3d for reducing the speed of the motor 3b and for converting its movement into a rotary movement of the spindle 3c. Optionally, the motor 3b may be in direct engagement on the spindle 3c. The arm 2 is inclined at an acute angle of about 14° with respect to the axis of symmetry of the rim in the tire mounting position, so that the first end of the arm 2 is further away from the axis of symmetry of the rim in the tire mounting position than the first end of said arm 2. In this way, the movement of this arm 2 during mounting of a tire on its rim is not obstructed by the angled position of the tire on said rim when the latter is brought to the device by a conveyor (not shown). The device according to the invention also comprises a third means 5 designed to displace the arm 2 orthogonally with respect to the axis of symmetry of the rim in the tire mounting position. This third means may comprise a hydraulic ram or any alternative means which performs the same function. By acting on the third means 5, it is possible to continuously adjust the position of the mounting head 4 and in particular to adjust the distance separating it from the abovementioned axis of symmetry, so as to allow the device to adapt to the mounting of tires on rims of various diameters of up to 24 inches or even more, it being possible for this device to be used on any commercial rim size by adapting the diameter of rotational travel of the head 4 to that of the rim on which a tire is to be mounted. Alternatively, the third means 5 also makes it possible to vary the distance of the head 4 relative to the axis of symmetry of the rim in the tire mounting position during the movement of revolution of said head 4 about said axis, so that the head 4 describes a revolution curve that is not circular but rather is for example elliptical or ovoid, so as to adapt to the mounting of tires on all types of rim, even non-circular rims, and to mount a bead of a tire on a flange or seat of its rim without any risk of damaging a surface of this bead and in particular the surface covered with fabric that it has generally on the side of this bead within the tire. The device is moreover provided with a fourth means 6 designed to displace the arm 2 parallel to the axis of symmetry of the rim in the tire mounting position. This fourth means may comprise a hydraulic ram or any other alternative means that performs the same function. The fourth means 6 can displace a plate 7 provided with sliding cylinders 9 designed to slide along uprights 8 that are essentially parallel to the axis of symmetry of the rim in the tire mounting position. The plate 7 bears the assembly consisting of the arm 2 and the second 3a-3d and third 5 means. It is thus possible to continuously adjust the height of the head 4 for mounting a tire on its rim as a function of the width of the latter. Such a displacement also makes it possible for said head 4 to mount a first peripheral bead of a first sidewall of the tire on a corresponding first peripheral flange or seat of a rim and then to be displaced vertically upward or downward so as to mount the second peripheral bead of the second sidewall of the tire in question on the second peripheral flange or seat of said rim. The arm 2 is provided with a fifth means 10, which may comprise a roller that can turn about its axis that is essentially parallel to the arm 2, said fifth means being designed to orient at a given angle a bead of the tire that is to be mounted on its rim, so that on the one hand this bead does not remain attached to the mounting head 4 and on the other hand the stretching of the cable within the bead during mounting of the tire on its rim is reduced to a minimum. This prevents the tire cable in question from breaking. The mounting head 4 essentially has the shape of a truncated cone or a truncated hemisphere, the axis of symmetry of which is inclined, by an angle of about 62°, with respect to the axis of symmetry of the rim in the tire mounting position, the base of said head then being inclined by an angle of about 28° with respect to this axis of symmetry. The device according to the invention, by virtue of the various adjustments of the mounting head 4 that it allows, is extremely versatile and makes it possible to process all types of rim and tire within very short periods, both for mounting a tire on a rim and for passing from one rim and/or tire format to another.

The device according to the invention moreover also comprises a programmable control unit (not shown) designed to receive information relating to the type of rim, the type of tire and the type of valve of said tire that is to be mounted on said rim, and to control in return the position of the arm 2 and of the head 4 during mounting of the tire on the rim.

FIGS. 2a-2c show in detail a first means of a device according to the invention, designed to receive a rim and place it in the position for mounting a tire on this rim. This first means comprises a first and a second parallel notched spindle 11a, 11b, respectively, which are coupled by a gearwheel 12 and arranged below the plane for receiving said rim in the mounting device. The spindles 11a, 11b are designed so that the displacement of one in one direction causes the displacement of the other in the opposite direction. Each of said spindles 11a and 11b is connected via a transmission block, 13a and 13b respectively, to a pair of clamps 14a and 14b, respectively, each block 13a, 13b is connected to sixth means, 15a, 15b respectively, which may comprise a hydraulic ram or any other means that can perform the same function, designed to apply a force to the block in question in the direction of the spindle 11a, 11b which said block connects to the pair of clamps in question and in opposite directions, so as to displace each clamp, in the direction of the spindle to which it is connected, between a position of engagement with a peripheral edge of the rim by each clamp and for mounting the tire and a position of disengagement from said peripheral edge by each clamp once said tire has been mounted. In this way, once the rim has been received in the device, it is placed in the tire mounting position by the pairs of clamps 14a and 14b which are displaced toward one another by the blocks which bear them, in the direction of the spindle to which they are connected. When they come into contact with the rim, the pairs of clamps 14a, 14b transmit to said rim the force applied by the means 15a, 15b to the blocks 13a and 13b, and block it in its tire mounting position, without this force being transmitted via the gearwheel 12, also referred to as the synchronization pinion. Once mounting has been carried out, the direction of the forces applied by the means 15a, 15b to the blocks 13a, 13b is reversed and the pairs of clamps 14a and 14b are moved away from one another so as to release the rim. The first means designed to receive a rim and place it in the tire mounting position likewise comprises a hub 16 which can be retracted below the plane for receiving the rim, designed to engage a central orifice of said rim when it is released from its tire mounting position once said tire has been mounted on said rim. Thus, the rim is held in place when the pairs of clamps 14a and 14b are disengaged. The first means also comprises two pairs of pins, 17a and 17b respectively, which can be retracted below the plane for receiving the rim and are designed to contact the inner edge of the rim with a view to holding it in place when it is released from its tire mounting position once said tire has been mounted on said rim. The movement of each pair of pins, 17a and 17b respectively, is coordinated with that of a corresponding pair of clamps, 14a, 14b respectively, a peripheral edge of the rim present in the device being arranged between a pair of pins and the corresponding pair of clamps once a tire has been mounted on its rim by the device. In this way, when a pair of clamps 14a, 14b approaches a peripheral edge of the rim, the corresponding pair of pins 17a, 17b moves apart and vice versa. Thus, the rim is held in place by the pins in question once the tire has been mounted and the pairs of clamps 14a and 14b move away from the rim, even if the latter does not comprise a central orifice that can receive the hub 16.

1. A device for mounting a tire on a vehicle rim, said device comprising a first means (1) designed to receive the rim and place it in the tire mounting position, an arm (2), a first end of which is equipped with a head (4) for mounting the tire on the rim, said head (4) being arranged so as to rotate about its axis of symmetry, a second means (3a, 3b, 3c, 3d) connected to the second end of the arm (2) and designed to transmit to said arm a movement of revolution about the axis of symmetry of the rim in the tire mounting position, characterized in that said arm (2) is inclined at an acute angle with respect to the axis of symmetry of the rim in the tire mounting position, the first end of the arm (2) thus being furthest away from the axis of symmetry of the rim in the tire mounting position.

2. The device as claimed in claim 1, characterized in that it comprises a third means (5) designed to displace the arm (2) orthogonally with respect to the axis of symmetry of the rim in the tire mounting position, and a fourth means (6) designed to displace the arm (2) parallel to the axis of symmetry of the rim in the tire mounting position.

3. The device as claimed in claim 2, characterized in that it comprises a fifth means (10) designed to orient at a given angle a bead of the tire that is to be mounted on its rim.

4. The device as claimed in claim 1, characterized in that the axis of rotation of the head (4) for mounting the tire is inclined at an acute angle with respect to the axis of symmetry of the rim in the tire mounting position.

5. The device as claimed in claim 4, characterized in that the head (4) for mounting the tire essentially has the shape of a truncated cone.

6. The device as claimed in claim 4, characterized in that the head (4) for mounting the tire essentially has the shape of a truncated hemisphere.

7. The device as claimed in claim 1, characterized in that it comprises a programmable control unit designed to receive information relating to the type of rim and the type of tire to be mounted, and to control in return the position of the arm (2) during mounting of the tire on the rim by the device.

8. The device as claimed in claim 3, characterized in that the first means (1) designed to receive the rim and place it in the tire mounting position comprises a first (11a) and a second (11b) notched spindle which are coupled by a gearwheel (12) and arranged below the plane for receiving said rim, each of said spindles (11a, 11b) being connected via a transmission block (13a, 13b) to at least one clamp (14a, 14b), each transmission block (13a, 13b) being connected to sixth means (15a, 15b) designed to apply a force to said block (13a, 13b) in the direction of the spindle (11a, 11b) which it connects to each clamp (14a, 14b) and in opposite directions, so as to displace each clamp (14a, 14b) between a position of engagement with a peripheral edge of the rim by each clamp (14a, 14b) and for mounting the tire and a position of disengagement from said peripheral edge by each clamp (14a, 14b) once said tire has been mounted on the rim.

9. The device as claimed in claim 8, characterized in that it comprises a hub (16) designed to engage a central orifice of said rim when it is released from its tire mounting position once said tire has been mounted on said rim.

10. The device as claimed in claim 8, characterized in that it comprises at least two pins (17a, 17b) designed to contact the inner edge of the rim with a view to holding it in place when it is released from its tire mounting position once said tire has been mounted on said rim.
